(19) United States
(12) Patent Application Publication
(10) Pub. No.: US 2005/0207822 A1
(43) Pub. Date: Sep. 22, 2005

(54) Writing apparatus having a show window

(76) Inventor: Joe Wang, Taipei (TW)

Correspondence Address: PRO-TECHTOR INTERNATIONAL, 20775 Norada Court, Saratoga, CA, 95070-3018, US

(21) Appl. No.: 10/803,532

(22) Filed: Mar. 16, 2004

(51) Int. Cl. B43K 29/00; B43K 7/06

(52) U.S. Cl. 401/193; 401/192

(57) ABSTRACT

A writing apparatus having a show window formed of a recessed receiving portion in the periphery of the pen body thereof and a transparent socket being detachably capped on the pen body for holding a picture, photo, advertising sheet member, or the like.

### BACKGROUND OF THE INVENTION

1. Field of the Invention

The present invention relates to a writing apparatus and more particularly, to such a writing apparatus, which has a show window for holding a show item, for example, a picture, photo, advertising sheet member, or the like.

2. Description of the Related Art

Conventionally, a writing apparatus, for example, a ballpoint pen or fountain pen, is limited to the purpose of writing only. Changes in shape, color, design, material, or structure may be made to attract consumers to buy. Lately, writing apparatus with added functions, such as light pen, calculator pen, pen drive, pen watch, pen with banknote acceptor, etc. are developed.

Further, because a writing apparatus is an inexpensive item that is requisite to most of the people, many companies use writing apparatus with an advertising printing as a gift to their clients. The advertising printing may be directly printed on the writing apparatus, or printed on a sheet member and then adhered to the writing apparatus. However, because the user's fingers may directly touch the advertising printing during writing, the advertising printing tends to be stained or forced away from the writing apparatus. Further, the advertising printing is not changeable when made.

### SUMMARY OF THE INVENTION

The present invention has been accomplished under the circumstances in view.

It is one object of the present invention to provide a writing apparatus, which has a show window for holding and protecting a show item, for example, a picture, photo, advertising sheet member, or the like.

It is another object of the present invention to provide a show window for a writing apparatus, which is re-openable for replacing the show item.

According to one aspect of the present invention, the writing apparatus comprises a pen body, which has a receiving portion in the periphery thereof adapted to accommodate a show item, and a transparent socket detachably capped on the pen body and forming with the receiving portion a show window to protect the show item in the receiving portion.

According to another aspect of the present invention, the pen body comprises a springy retaining stub rod protruded from a spring strip thereof adapted to lock the transparent socket, and the transparent socket comprises a retaining hole adapted to receive the springy retaining stub rod.

### BRIEF DESCRIPTION OF THE DRAWINGS

FIG. 1 is an elevational view of a writing apparatus according to the preferred embodiment of the present invention.

FIG. 2 is an exploded view of the writing apparatus according to the preferred embodiment of the present invention.

FIG. 3 is a longitudinal view in section of the lower part of the writing apparatus according to the preferred embodiment of the present invention.

FIG. 4 is a cross-sectional view taken along line A-A of FIG. 3.

FIG. 5 is a cross-sectional view taken along line B-B of FIG. 3.

### DETAILED DESCRIPTION OF THE PREFERRED EMBODIMENT

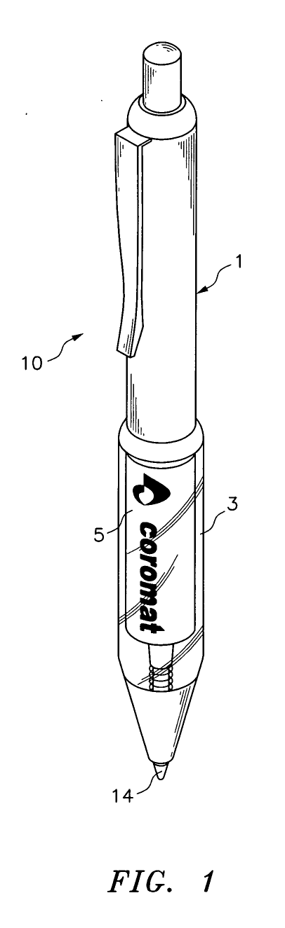

Referring to FIGS. 1˜3, a writing apparatus 10 is shown comprising a pen body 1 and a transparent socket 3. According to this embodiment, the writing apparatus 10 is a pushbutton ballpoint pen with a clip. The pen body 1 comprises a barrel 11, an ink cartridge 13 mounted in the barrel 11, and a compression spring 14 supporting the ink cartridge 13 inside the barrel 11. The barrel 11 has a flange 19 extended around the periphery on the middle, and a receiving portion 12 in the periphery adapted to accommodate a thin sheet member 5. According to this embodiment, the receiving portion 12 is a recess formed in the periphery of the barrel 11 below the flange 19. The recessed receiving portion 12 may be formed in the upper part of the barrel 11 of the pen body 1 or any suitable location at the periphery of the barrel 11 if the writing apparatus 10 is not made in the form of a ballpoint pen. The thin sheet member 5 can be a picture, photo, or advertising printing matter that fits the recessed receiving portion 12.

The transparent socket 3 is capped on the front part of the barrel 11 of the pen body 1 and stopped below the flange 19 to support the compression spring 13 and the ink cartridge 14. After installation of the transparent socket 3 in the pen body 1, the transparent socket 3 and the recessed receiving portion 12 form a show window through which the thin sheet member 5 (show item) is seen.

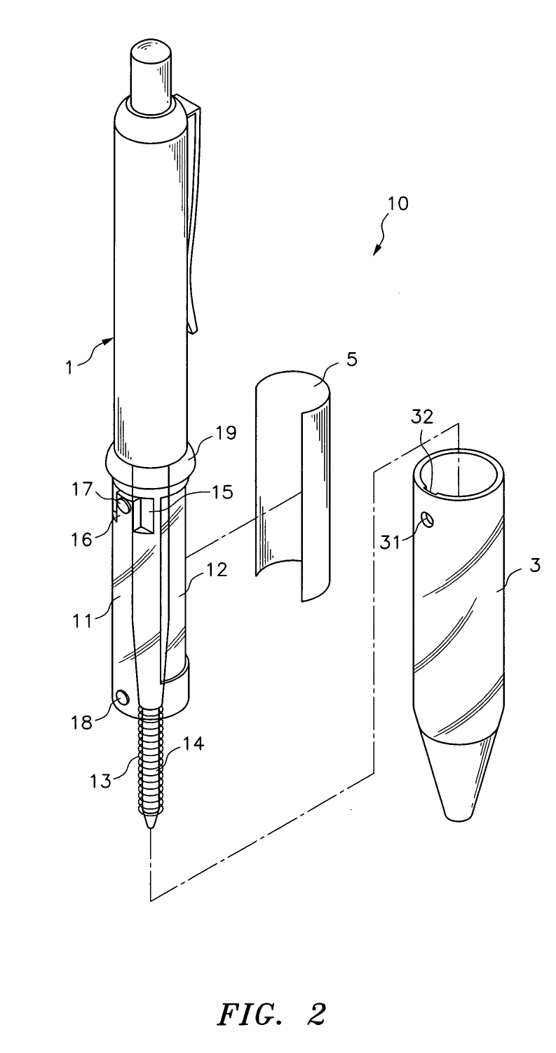

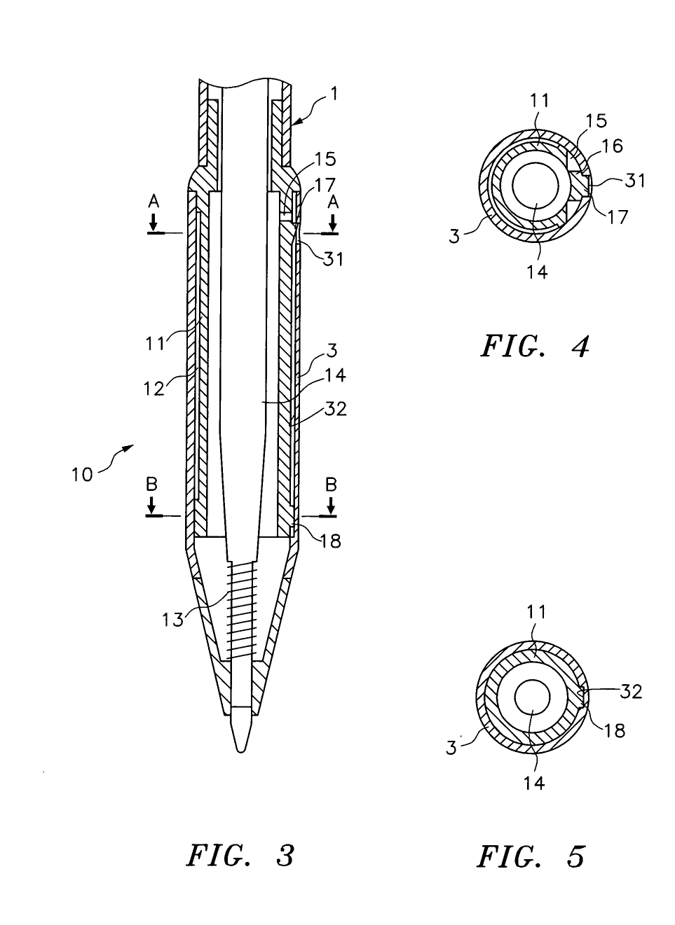

Referring to FIG. 4 and FIGS. 2 and 3 again, the barrel 11 has a U-slot 15 invertedly disposed above the recessed receiving portion 12, defining an upwardly extended spring strip 16. The spring strip 16 has a protruded retaining stub rod 17 outwardly projected from the free end (top end). The transparent socket 3 has a retaining hole 31 corresponding to the retaining stub rod 17. When capping the transparent socket 3 on the barrel 11, the retaining hole 31 of the transparent socket 3 is forced into engagement with the retaining stub rod 17, and therefore the transparent socket 3 is locked to the barrel 11. Inserting a thin rod member or pointed tip member into the retaining hole 31 to push the retaining stub rod 17 inwardly away from the retaining hole 31, the transparent socket 3 is unlocked and can be removed from the barrel 11.

Referring to FIG. 5 and FIGS. 2 and 3 again, in order to guide the transparent socket 3 into the locking position, a guide structure is provided, i.e., a guide rod 18 is provided at the periphery of the barrel 11 near the bottom end right below the spring strip 16 and a sliding groove 32 is formed in the inside wall of the transparent socket 3 and vertically downwardly extended from the top end of the transparent socket 3. By means of engaging the guide rod 18 into the sliding groove 32, the transparent socket 3 can quickly be capped on the barrel 11 and set into the locking position where the retaining stub rod 17 engages the retaining hole 31. Upon setting of the transparent socket 3 into the locking position, the transparent socket 3 is stopped against the flange 19, and the retaining stub rod 17 is forced into the retaining hole 31, producing a click sound.

A prototype of writing apparatus having a show window has been constructed with the features of FIGS. 1˜5. The writing apparatus having a show window functions smoothly to provide all of the features discussed earlier.

Although a particular embodiment of the invention has been described in detail for purposes of illustration, various modifications and enhancements may be made without departing from the spirit and scope of the invention.

1. A writing apparatus comprising:
a pen body, said pen body having a receiving portion in the periphery thereof adapted to accommodate a show item; and
a transparent socket capped on said pen body and forming with said receiving portion a show window adapted to hold and protect a shown item.

2. The writing apparatus as claimed in claim 1, wherein said receiving portion is a recess.

3. The writing apparatus as claimed in claim 1, wherein said pen body comprises a springy retaining stub rod protruded from a spring strip thereof adapted to lock said transparent socket; said transparent socket comprises a retaining hole adapted to receive said springy retaining stub rod.

4. The writing apparatus as claimed in claim 3, further comprising a guide structure adapted to guide the retaining hole of said transparent socket into engagement with the springy retaining stub rod of said pen body.

5. The writing apparatus as claimed in claim 4, wherein said guide structure comprises a guide rod protruded from the periphery of said pen body, and a sliding groove longitudinally formed in an inside wall of said transparent socket and adapted to receive said guide rod.

6. The writing apparatus as claimed in claim 4, wherein said guide structure comprises a guide rod protruded from an inside wall of said transparent socket, and a sliding groove longitudinally formed in the periphery of said pen body and adapted to receive said guide rod.
